(19) United States
(12) Patent Application Publication
(10) Pub. No.: US 2005/0012758 A1
(43) Pub. Date: Jan. 20, 2005

(54) Digital picture frame

(76) Inventor: Charlotte L. Christou, Mulberry, FL (US)

Correspondence Address: EDWARD M. LIVINGSTON, PA, 963 TRAIL TERRACE DRIVE, NAPLES, FL, 34103, US

(21) Appl. No.: 10/872,814

(22) Filed: Jun. 21, 2004

Related U.S. Application Data
(60) Provisional application No. 60/482,796, filed on Jun. 25, 2003.

(51) Int. Cl. H04N 7/26

(52) U.S. Cl. 345/619

(57) ABSTRACT

A digital picture frame comprised of a display screen (2), a front bezel (1) and an image reader (8) which accommodates various image input (23). The device also has a wireless transceiver (9) provided so a user can download digital images directly from a LAN. The device has easy to use controls to allow the user to manipulate the images to his or her preference. The device is powered by batteries or an AC adapter (7) or (35). An interchangeable frame (28) allows the user to coordinate the frame with his or her personal style while an optional light sensor (31) permits automatic shut off of the device when light is low or not present. Built-in color correction and scaling features allow for further ease of use. The device can stand on its own or be mounted on a wall.

### CROSS-REFERENCE TO RELATED APPLICATION

This is application claims the benefit of U.S. Provisional Application No. 60/482,796, filed Jun. 25, 2003.

### BACKGROUND OF THE INVENTION

This invention relates to picture frames and, more specifically, to a lightweight electronic digital picture frame that uses image input, such as memory cards, compact discs (“CDs”), wireless transmission or other means from digital cameras to display digital images, including without limitation pictures and graphics on an LCD screen, without requiring connection to the camera or computer as with other digital picture frames.

Current digital picture frames use memory cards from digital cameras to display digital pictures and accompanying audio. However, these frames can only accept one type of image input without requiring adaptors. In addition, the display simply showed the digital image taken “as is”, without any type of means for correcting the color quality of the image. Further, the frames only display one image at a time, thus requiring the user to choose one image among his or her favorites to display before manually changing the settings to choose another image. In addition, the frames display only still images, rather than both still and moving images. Also, the frames themselves are visually unappealing as they cannot be customized to match the owner's decor. In addition, the frames do not include a means for self shut off.

Thus, the need exists for a new digital frame that accommodates various image input media, including, but not limited to memory cards such as SmartMedia™, CompactFlash™, Secure Digital™ xD-Picture Card™ and Memory Stick™, without the use of adaptors or connection to other peripherals, has a means for correcting the quality of the pictures, displays both still and moving images, allows a user to view numerous images as thumbnails, allows a user to flip through numerous pages of thumbnail images, allows a user to set a time interval between displayed images, has an interchangeable frame to compliment any decor and has an optional light-sensitive shut off means.

The relevant prior art includes the following patents:

| Pat. No. | | |
|---|---|---|
| (U.S. unless | | |
| stated otherwise) | Inventor | Issue Date |
| 6,535,139 | Lindler | Mar. 18, 2003 |
| D464,050 | Mori | Oct. 08, 2002 |
| 6,396,472 | Jacklin | May 28, 2002 |
| D446,809 | Parker | Aug. 21, 2001 |
| 6,037,954 | McMahon | Mar. 14, 2000 |
| D396,351 | Patkunan | Jul. 28, 1998 |
| 5,703,624 | van Kruistum | Dec. 30, 1997 |
| 5,504,826 | Loudermilk | Apr. 02, 1996 |
| 5,438,344 | Olivia | Aug. 01, 1995 |
| 4,888,648 | Takeuchi et al. | Dec. 19, 1989 |
| 4,717,971 | Sawyer | Jan. 05, 1988 |
| 5,582,373 | Baudot | Dec. 10, 1996 |
| 5,170,388 | Endoh | Dec. 08, 1992 |
| 4,754,271 | Edwards | Jun. 28, 1988 |
| 5,608,608 | Flint et al. | Mar. 04, 1997 |
| 5,604,512 | Okamoto et al. | Feb. 18, 1997 |
| 5,484,292 | McTaggart | Jan. 16, 1996 |
| 5,461,596 | Barrett | Oct. 24, 1995 |
| 5,335,192 | Oshiba | Aug. 02, 1994 |
| 5,329,289 | Sakamoto et al. | Jul. 12, 1994 |

### SUMMARY OF THE INVENTION

The primary object of the present invention is to provide a stand alone digital picture frame that is compatible with various types of image input media not tied to the Internet or PC.

Another object of the present invention is to provide a stand alone digital picture frame that is easy to use.

An even further object of the present invention is to provide a stand alone digital picture frame that has an interchangeable frame.

Another object of the present invention is to provide a stand alone digital picture frame that has a light sensor to turn the frame off at night.

Another object of the present invention is to provide a stand alone digital picture frame that is relatively affordable.

Another object of the present invention is to provide a stand alone digital picture frame that has a display.

A further object of the present invention is to provide a stand alone digital picture frame that has a built-in color correction feature.

An even further object of the present invention is to provide a stand alone digital picture frame that has a built-in scaling feature.

Another object of the present invention is to provide a stand alone digital picture frame that displays images as thumbnails.

An additional object of the present invention is to provide a stand alone digital picture frame that permits a user to flip through various pages of thumbnail images.

The present invention fulfills the above and other objects by providing a stand alone digital picture frame comprised of a display screen, front bezel and image reader which accommodates various image input media, such as memory cards including, but not limited to, SmartMedia™, CompactFlash™, Secure Digital™ xD-Picture Card™ or Memory Stick™ and other types of memory storage devices. The device has easy to use controls, including, but not limited to: a power button, rotate button, folder button, next button, play/pause button, previous button, +/−brightness button, mode button and menu button. The controls allow the user to manipulate the images to his or her preference. The device is versatile as it is battery or AC adapter operated. An interchangeable frame allows the user to coordinate the frame with his or her personal style while an optional light sensor permits automatic shut off of the device when light is low or not present.

To use the present invention, a user simply inserts an image input media into the side receptor to allow the software algorithm to recognize the digital images. Once recognized, the images are available for viewing in either a still or slide show format. The user can further manipulate the images according to his or her preferences by using features located on a button bar.

The invention can be placed on a planar surface by use of a rotating stand or mounted on a wall. The present invention also includes interchangeable frames which can snap onto the front bezel so a user can coordinate the frame with any decor.

The above and other objects, features and advantages of the present invention should become even more readily apparent to those skilled in the art upon a reading of the following detailed description in conjunction with the drawings wherein there is shown and described illustrative embodiments of the invention.

### BRIEF DESCRIPTION OF DRAWINGS

In the following detailed description, reference will be made to the attached drawings in which:

FIG. 1 is a front view of the stand alone digital picture frame of the present invention;

FIG. 2 is a side view of the right side of the embodiment of FIG. 1;

FIG. 3 is a side view of the left side of the embodiment of FIG. 1;

FIG. 4 is a top view of the embodiment of FIG. 1;

FIG. 5 is a bottom view of the embodiment of FIG. 1;

FIG. 6 is a rear view of the embodiment of FIG. 1;

FIG. 7 is a side view of the embodiment of FIG. 1 with the stand enacted;

FIG. 8 is a perspective view of an interchangeable frame of the present invention; and

FIG. 9 is a block diagram showing the operation of the digital picture frame of FIG. 1.

### DESCRIPTION OF PREFERRED EMBODIMENT

For purposes of describing the preferred embodiment, the terminology used in reference to the numbered components in the drawings is as follows:

| | |
|---|---|
| 1. | front bezel |
| 2. | display screen |
| 3. | right side |
| 4. | left side |
| 5. | top side |
| 6. | bottom side |
| 7. | first AC adapter input |
| 8. | image reader |
| 9. | wireless transceiver |
| 10. | power button |
| 11. | mode button |
| 12. | + brightness button |
| 13. | − brightness button |
| 14. | rotate button |
| 15. | folder button |
| 16. | next button |
| 17. | play/pause button |
| 18. | previous button |
| 19. | menu button |
| 20. | screws |
| 21. | stand |
| 22. | rear cover |
| 23. | image input media |
| 24. | software algorithm |
| 25. | RAM |
| 26. | ROM |
| 27. | controller |
| 28. | interchangeable frame |
| 29. | eject button |
| 30. | battery compartment |
| 31. | light sensor |
| 32. | means for hanging |
| 33. | clips |
| 34. | grooves |
| 35. | second AC adapter input |

1. front bezel 19. menu button 2. display screen 20. screws 3. right side 21. stand 4. left side 22. rear cover 5. top side 23. image input media 6. bottom side 24. software algorithm 7. first AC adapter input 25. RAM 8. image reader 26. ROM 9. wireless transceiver 27. controller 10. power button 28. interchangeable frame 11. mode button 29. eject button 12. + brightness button 30. battery compartment 13. − brightness button 31. light sensor 14. rotate button 32. means for hanging 15. folder button 33. clips 16. next button 34. grooves 17. play/pause button 35. second AC adapter input 18. previous button

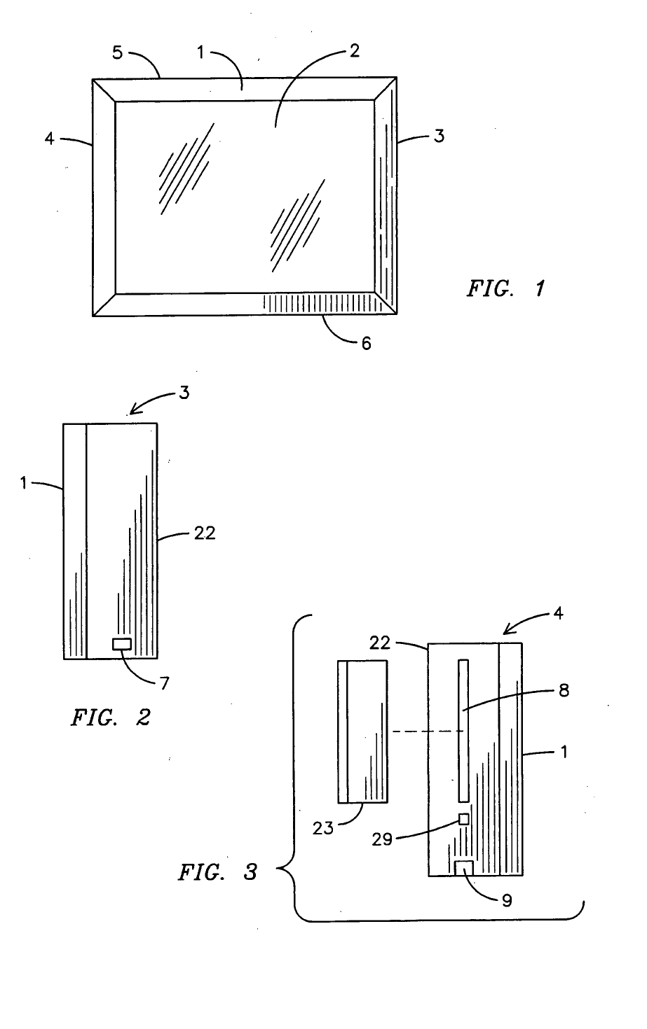

Referring to FIG. 1, a front view of the digital picture frame of the present invention is shown. The display screen 2 has a right side 3, a left side 4, a top side 5 and a bottom side 6 and is surrounded on all sides by a front bezel 1. The display screen 2 preferably has dimensions of 203 mm width by 260 mm length by 44 mm thickness. The display screen 2 can be of any type or size, such as a color organic light emitting diode (“OLED”) or a paper-thin display, but is preferably a color LCD screen 10 inches, measured diagonally. The display screen 2 can have almost any resolution, but preferably has a resolution of 800 by 600 pixels.

With reference to FIG. 2, a front bezel 1 is attached to a rear cover 22 to house the electronic equipment describe further in the application. A first AC adapter input 7, preferably ranging from 110-240 VAC, is provided on the rear cover 22 to allow a user to supply power to the invention while the frame is in use horizontally.

FIG. 3 shows a side view of the left side 4 of the embodiment of FIG. 1. An image input media 23 is inserted into an image reader 8, preferably located on a left side 4 for the software algorithm 24 to recognize. At least one image reader 8 is provided in the present invention, although the preferred embodiment includes two image readers 8, one for SmartMedia™ and one for CompactFlash™. An eject button 29 is provided so as to allow the user easy removal of the digital camera card. In addition, a wireless transceiver 9 is also provided so a user can download digital pictures directly from a local area network (LAN).

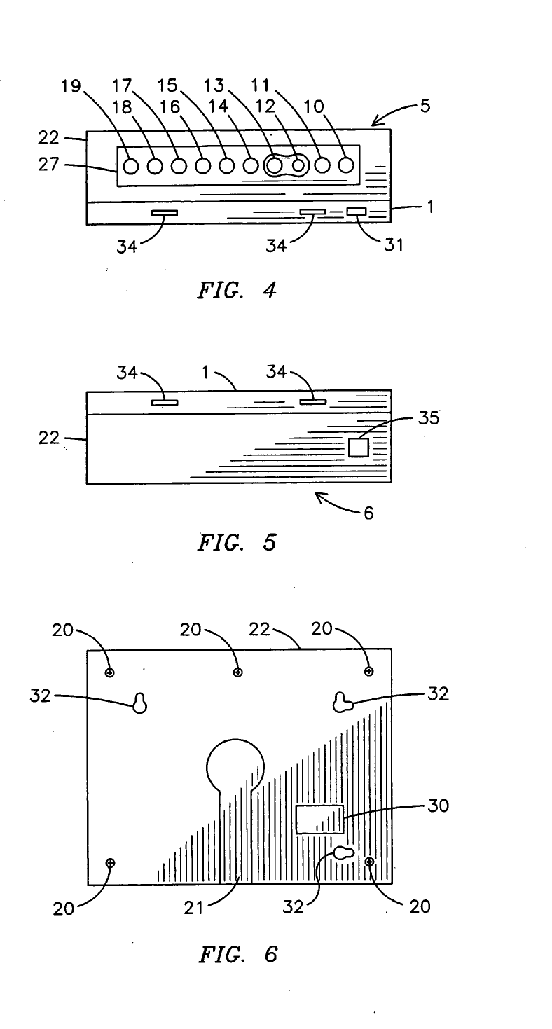

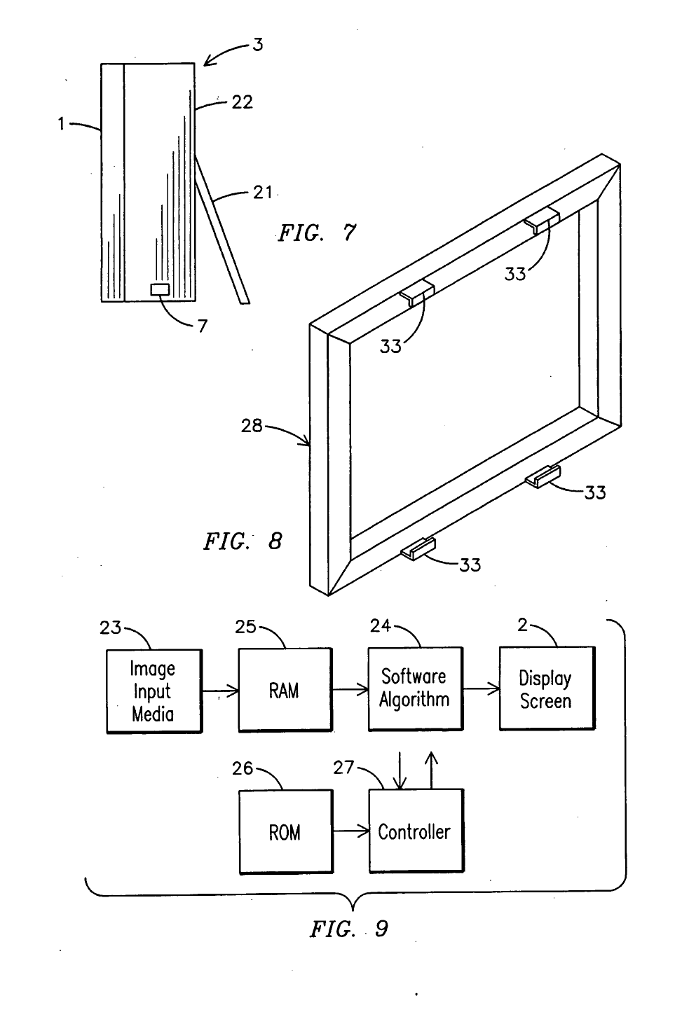

FIG. 4 shows the top side 5 of the embodiment of FIG. 1. The buttons 10 to 19 on the controller 27 represent different operations of the invention: power button 10, mode button 11, +brightness button 12, −brightness button 13, rotate button 14, folder button 15, next button 16, play/pause button 17, previous button 18, and menu button 19. In addition, an optional light sensor 31 is provided so as to allow the device to shut itself off when little or no light is present. The front bezel 1 also has grooves 34 on the top side 5 for the accommodation of an interchangeable frame 28, as shown in FIG. 8.

With reference to FIG. 5, a bottom view of the embodiment of FIG. 1 is shown. A second AC adapter input 35, preferably 110-240 VAC, is located on the bottom side 6 to allow a user to supply power to the invention while the frame is in use vertically. The front bezel 1 also has grooves 34 on the bottom side 6 for the accommodation of an interchangeable frame 28, as shown in FIG. 8.

Referring to FIG. 6, the rear cover 22 is secured to the front bezel 1 by five screws 20. The stand 21 is attached to the rear cover 22 and swivels for portrait or landscape views. A means for hanging 32, preferably a slot, is also provided so as to permit the user to hang the device on a wall. In addition, a battery compartment 30 is provided to permit the user to use batteries to power the invention.

Referring to FIG. 7, a side view of the embodiment of FIG. 1 with the stand enacted is shown. The stand 21 enables the user to display the frame on a table, counter or other planar surface. The stand 21 is rotational so as to allow the user to place the frame in a vertical or horizontal position.

With reference to FIG. 8, a perspective view of an interchangeable frame 28 of the present invention is shown. The interchangeable frame 28 has clips 33 which lock into the grooves 34 located on the front bezel 1. This feature allows the user to further customize the device to suit any decor.

Finally, FIG. 9 is a block diagram showing the operation of the embodiment of FIG. 1. The digital image in the image input media 23 is recognized and stored in the RAM 25, enhanced by the software algorithm 24 and then outputted to the display screen 2. A controller 27 is connected to the ROM 26 so as to allow an automatic slideshow or to allow the user to modify the digital images and view the modified images on the display screen 2.

To use the present invention, a user simply inserts an image input media 23 into the image reader 8 and the digital images are transferred to and stored in the RAM 25. Then, the software algorithm 24 recognizes the digital images and detects whether they are landscape or portrait oriented and further enhances the images wherein the revised images are outputted onto the display screen 2 in an automatic slideshow. The user can then adjust the image according to his or her preference, whereby he or she can rotate the image, freeze frame a specific image, adjust the brightness of the image, sequence the images or page through thumbnail views of the images without compromising clarity of the image, and so on. The number of digital images that can be displayed on the device is limited only by the image input media 23 capacity and the device is programmed so as to display each image on the image input media 23 in a predetermined time interval, preferably five (5) seconds per picture. Additionally, the device allows a user to view numerous images, called thumbnails, on the display screen 2 at one time to display a thumbnail page. A user may flip through thumbnail pages by using the appropriate button on the button bar, thereby allowing the user to quickly retrieve the image for which he or she is searching.

The device could also have printing capabilities and utilize a touch screen, rather than a button bar, for easier operating use.

It is to be understood that while a certain form of the invention is illustrated, it is not to be limited to the specific form or arrangement of parts herein described and shown. It will be apparent to those skilled in the art that various changes may be made without departing from the scope of the invention and the invention is not be considered limited to what is shown and described in the specification and drawings.

1. A digital picture frame comprising:
a display screen for displaying images;
a front bezel which surrounds said display screen;
a rear cover connected to the front bezel;
a RAM connected to the display screen and located between the display screen and the rear cover;
a software algorithm connected to the RAM and located between the display screen and the rear cover;
a means for powering the display screen, the RAM and the software algorithm; and
a means for manipulating images on the display screen connected to the RAM and the software algorithm.

2. The digital picture frame of claim 1 wherein:
at least one image reader is connected to the software algorithm.

3. The digital picture frame of claim 1 wherein:
the display screen is LCD.

4. The digital picture frame of claim 1 wherein:
the display screen is OLED.

5. The digital picture frame of claim 1 wherein:
a wireless transceiver is connected to the software algorithm.

6. The digital picture frame of claim 2 wherein:
a wireless transceiver is connected to the software algorithm.

7. The digital picture frame of claim 1 wherein:
a power button is connected to the display screen, the software algorithm and the RAM.

8. The digital picture frame of claim 1 wherein:
the means for manipulation is via a controller.

9. The digital picture frame of claim 1 wherein:
a pivoting stand is attachable to the rear cover.

10. The digital picture frame of claim 1 wherein:
the means for powering is a battery.

11. The digital picture frame of claim 1 wherein:
the means for powering is AC.

12. The digital picture frame of claim 2 wherein:
an eject button is located adjacent the at least one image reader.

13. The digital picture frame of claim 1 wherein:
an interchangeable frame is attachable to the front bezel.

14. The digital picture frame of claim 1 wherein:
a light sensor is connected to the display screen.

15. The digital picture frame of claim 8 wherein:
the controller has a plurality of functional buttons.

16. The digital picture frame of claim 2 wherein:
the at least one image reader accommodates various image input media.

17. The digital picture frame of claim 16 wherein:
the image input media is SmartMedia™.

18. The digital picture frame of claim 16 wherein:
the image input media is CompactFlash™.

19. The digital picture frame of claim 16 wherein:
the image input media is Secure Digital™.

20. The digital picture frame of claim 16 wherein:
the image input media is Memory Stick™.

21. The digital picture frame of claim 16 wherein:
the image input media is xD.

22. The digital picture frame of claim 16 wherein:
the image input media is compact disc.

23. The digital picture frame of claim 16 wherein:
the image input media is wireless.

24. The digital picture frame of claim 1 wherein:
a scaling feature is built into the software algorithm.

25. The digital picture frame of claim 1 wherein:
a color correction feature is built into the software algorithm.

26. The digital picture frame of claim 1 wherein:
the rear cover has a means for hanging.
